(19) United States
(12) Patent Application Publication
(10) Pub. No.: US 2021/0337690 A1
(43) Pub. Date: Oct. 28, 2021

(54) DISPLAY PANEL, MANUFACTURING METHOD THEREOF AND DISPLAY DEVICE

(71) Applicant: Wuhan China Star Optoelectronics Technology Co., Ltd., Wuhan (CN)

(72) Inventor: Yicheng CHEN, Wuhan (CN)

(73) Assignee: Wuhan China Star Optoelectronics Technology Co., Ltd., Wuhan (CN)

(21) Appl. No.: 16/939,093

(22) Filed: Jul. 27, 2020

(30) Foreign Application Priority Data
Apr. 27, 2020 (CN) 202010342644.4

(51) Int. Cl. H05K 5/03; H05K 5/00

(52) U.S. Cl. CPC H05K 5/03; H05K 5/0017

(57) ABSTRACT

A display panel, a manufacturing method thereof and a display device are provided. The display panel includes a cover plate, an adhesive layer, and a light-shielding glue. The cover plate has an edge area. The cover plate has a filling groove in the edge area, and the light-shielding glue is filled in the filling groove.

### RELATED APPLICATION

This application claims the benefit of priority of Chinese Patent Application No. 202010342644.4 filed on Apr. 27, 2020, the contents of which are incorporated herein by reference in their entirety.

### FIELD AND BACKGROUND OF THE INVENTION

The present disclosure relates to fields of display devices, and in particular to display panels, manufacturing methods thereof, and display devices.

With the development of display technology, full-lamination technologies have become the mainstream manufacturing process of various module manufacturers, and have the advantages, such as reducing glare and brightness loss of products, and improving the overall strength of products. However, in the existing full-lamination technologies, there is a certain gradient in an ink coating edge area of a cover plate. If the gradient is greater, a thickness of the adhesive layer is greater, which causes an overall thickness of the cover plate to become greater. Moreover, it is difficult for an optical glue to fill the ink coating edge area, thereby forming air bubbles, and additionally, the restriction of an ultra-thin stacked structure design causes the air bubbles in the edge area to be apparent. In addition, the gradient of the ink coating edge area increases the resistance of the coating edge area, and further hinders the filling ability of the optical glue, so as to form recurring bubbles, and then affect the stability of the cover plate.

### SUMMARY OF THE INVENTION

An object of the present disclosure is to provide a display panel, a manufacturing method thereof, and a display device, to solve the problems existing in the prior art that the cover plate has poor stability, and air bubbles exist between an adhesive layer and an ink layer.

In order to achieve the above object, the present disclosure provides a display panel, including: a cover plate, an adhesive layer, and a light-shielding glue; the cover plate having a bonding surface and a non-bonding surface, the non-bonding surface facing opposite to the bonding surface; the cover plate having a main body area and an edge area on the non-bonding surface, the edge area surrounding the main body area; the cover plate further having a filling groove in the edge area; the adhesive layer covering the bonding surface of the cover plate; and the light-shielding glue filled in the filling groove.

Furthermore, a depth of the filling groove ranges from 20 to 30 um.

Furthermore, a thickness of the light-shielding glue is equal to a depth of the filling groove.

Furthermore, the light-shielding glue is ink.

Furthermore, the display panel further includes: a scratch-resistant layer covering the light-shielding glue and the non-bonding surface of the cover plate.

Furthermore, material of the adhesive layer including an optical adhesive.

The present disclosure further provides a manufacturing method of a display panel, including following steps of:

Providing a cover plate, the cover plate having a bonding surface and a non-bonding surface, the non-bonding surface facing opposite to the bonding surface. The cover plate has a main body area and an edge area on the non-bonding surface, and the edge area surrounds the main body area.

Forming a filling groove in the edge area of the cover plate.

Filling a light-shielding glue in the filling groove.

Forming an adhesive layer on the bonding surface of the cover plate.

Furthermore, after the step of forming the light-shielding glue, the manufacturing method further includes a following step of: forming a scratch-resistant layer on the non-bonding surface of the cover plate.

Furthermore, a depth of the filling groove ranges from 20 to 30 um.

The present disclosure yet provides a display device, including: the display panel as described above.

The advantages of the present disclosure are as follows: in the display panel of the present disclosure, the light shielding layer is filled onto the non-bonding surface of the cover plate, thereby improving the bonding degree of the adhesive layer on the bonding surface of the cover plate, reducing the generation of the air bubbles, improving the reliability and stability of the products, and further reducing a thickness of the display panel. Moreover, the preparation process is simple, and the preparation materials are simple and is easily obtained.

### BRIEF DESCRIPTION OF THE SEVERAL VIEWS OF THE DRAWING(S)

In order to more clearly explain the technical solutions in the embodiments of the present disclosure, the drawings accompanying with the description of the embodiments will be briefly introduced below. It is apparent that the drawings in the following description are only some embodiments of the present disclosure. For those skilled in the art, without paying any creative work, other drawings can also be obtained based on these drawings.

FIG. 1 is a layered schematic view of a display panel according to an embodiment of the present disclosure.

FIG. 2 is a schematic plan view of a non-bonding surface of a cover plate according to the embodiment of the present disclosure.

FIG. 3 is a schematic flow chart of the manufacturing method according to the embodiment of the present disclosure.

FIG. 4 is a layered schematic view in a step S10 according to an embodiment of the present disclosure.

FIG. 5 is a layered schematic view in a step S20 according to an embodiment of the present disclosure.

FIG. 6 is a layered schematic view in a step S30 according to an embodiment of the present disclosure.

The components in the figures are as follows:
Display panel 100.
Cover plate 10; bonding surface 11.
Non-bonding surface 12; main body area 13.
Edge area 14; filling groove 20.
Light shielding glue 30; scratch-resistant layer 40.
Glue layer 50.

### DESCRIPTION OF SPECIFIC EMBODIMENTS OF THE INVENTION

The following description describes preferred embodiments of the present disclosure with reference to the accompanying drawings to prove that the present disclosure can be implemented. The embodiments of the present disclosure can fully introduce the present disclosure to those skilled in the art to make its technical content more clear and easy to understand. The present disclosure can be embodied by many different forms of embodiments of the present disclosure, and the protection scope of the present disclosure is not limited to the embodiments mentioned herein.

In the drawings, components with the same structure are denoted by the same numerals, and components with similar structures or functions are denoted by similar numerals. The size and thickness of each component shown in the drawings are arbitrarily shown, and the present disclosure does not limit the size and thickness of each component. In order to make the illustration more clear, the thicknesses of the components are exaggerated appropriately in some places in the drawings.

In addition, the following description refers to the accompanying drawings to illustrate specific embodiments of the present disclosure that can be implemented by the present disclosure. Directional terms mentioned in the present disclosure, for example, “upper”, “lower”, “front”, “rear”, “left”, “right”, “inner”, “outer”, “side”, etc., only refers to the directions of the accompanying drawings. Therefore, the directional terms are used for better and clearer illustrating and understanding of the present disclosure, rather than indicating or implying that the device or element referred to must have a specific orientation, construction and operation with a specific orientation. Therefore, it cannot be understood as a limitation of the present disclosure. In addition, the terms “first”, “second”, “third”, etc. are for descriptive purposes only and cannot be understood as indicating or implying relative importance.

When certain components are described as “on” another component, the component may be placed directly on the other component; or there may also be an intermediate component, the component is placed on the intermediate component, and the intermediate component is placed on another component. When a component is described as “mounted to” or “connected to” another component, both can be understood to be “mounted” or “connected” directly, or a component indirectly “mounted to” or “connected to” another part through an intermediate component.

An embodiment of the present disclosure provides a display device. The display device includes a display panel 100 for providing a display screen for the display device. The display device may be any display device with a display function, such as a mobile phone, a notebook computer, a television, and so on.

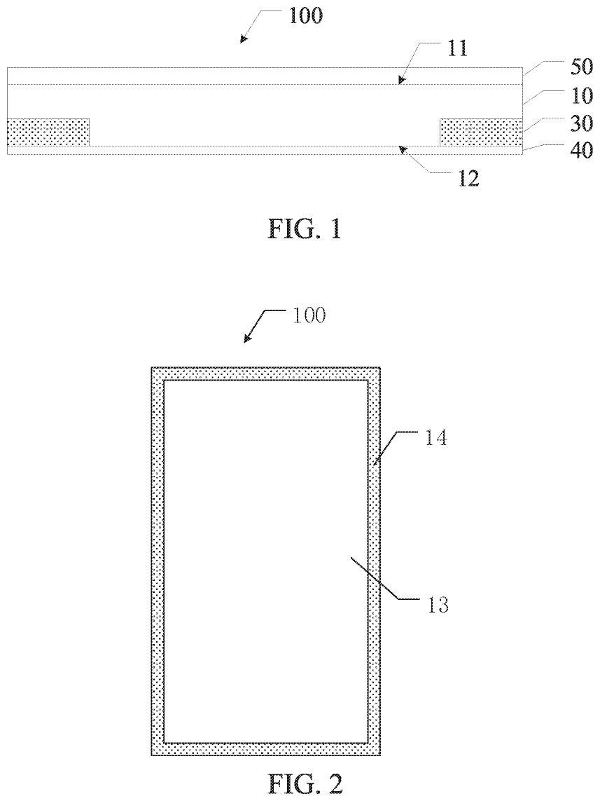

As shown in FIG. 1, the display panel 100 has a cover plate 10. The cover plate 10 has a bonding surface 11 and a non-bonding surface 12 facing opposite to the bonding surface 11. The bonding surface 11 is used for bonding other components of the display panel 100. As shown in FIG. 2, the cover plate 10 has a main body area 13 and an edge area 14 on the non-bonding surface 12, the edge area 14 surrounds the main body area 13.

The cover plate 10 has a filling groove 20 in the edge area 14, and the filling groove 20 surrounds the main body area 13.

The filling groove 20 is filled with a light-shielding glue 30. The light-shielding glue 30 generally uses ink material to shield light, so as to prevent light leakage from a side of the display panel 100, and improve the display screen quality of the display panel 100.

A depth of the filling groove 20 ranges from 20 to 30 um, and a filling thickness of the light-shielding glue 30 is equal to the depth of the filling groove 20, so that the non-bonding surface 12 of the cover plate 10 is a flat surface, without a height difference, to increase the smoothness of the non-bonding surface 12 of the cover plate 10, and improve the user experience.

The display panel 100 further has an adhesive layer 50 and a scratch-resistant layer 40.

The adhesive layer 50 is disposed on the bonding surface 11 of the cover plate 10, and generally uses an optically clear adhesive (OCA). The adhesive layer 50 is used to increase the adhesive strength of the cover plate 10.

The scratch-resistant layer 40 is coated on a layer of the light-shielding glue 30 and the non-bonding surface 12 of the cover plate 10, which is used to prevent the layer of the light-shielding glue 30 from peeling off and increase the stability of the light-shielding glue 30, and can protect the cover plate 10, to increase the strength of the cover plate 10, and reduce the risk of being broken.

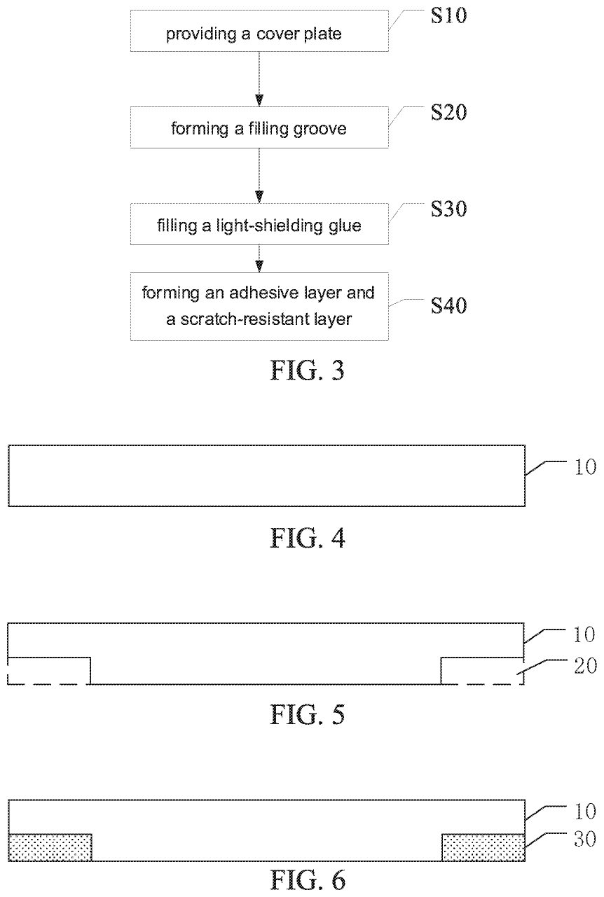

The present disclosure also provides a manufacturing method of the display panel 100 as described above. The manufacturing process is shown in FIG. 3, which includes following steps of:

A step S10 of providing a cover plate 10: as shown in FIG. 4, the cover plate 10 is generally a glass cover plate 10, which has a bonding surface 11 and a non-bonding surface 12 facing opposite the bonding surface 11. The cover plate 10 has a main body area 13 and an edge area 14 on the non-bonding surface 12, and the edge area 14 surrounds the main body area 13.

A step S20 of forming a filling groove 20: as shown in FIG. 5, the filling groove 20 is carved in the edge area 14 of the cover plate 10 by a laser process, and a depth of the filling groove 20 ranges from 20 to 30 μm.

A step S30 of filling a light-shielding glue 30: as shown in FIG. 6, the filling groove 20 is filled with ink, and the light-shielding layer is formed after curing. A thickness of the light-shielding layer ranges from 20 to 30 μm.

A step S40 of forming an adhesive layer 50 and a scratch-resistant layer 40: a layer of scratch-resistant material is coated on the non-bonding surface 12 of the cover plate 10 and the light-shielding layer, and the scratch-resistant layer 40 is formed after curing. A layer of optical glue is dispensed on the bonding surface 11 of the cover plate 10 to form the adhesive layer 50, and the display panel 100 is formed as shown in FIG. 1.

An embodiment of the present disclosure provides a display panel 100 which fills a light-shielding layer on the non-bonding surface 12 of the cover plate 10, thereby improving the bonding degree of the adhesive layer 50 on the bonding surface 11 of the cover plate 10, reducing the generation of the air bubbles, and improving the reliability and stability of the product. Moreover, because the display panel 100 provided in the embodiments of the present disclosure is filled with the light shielding layer in the cover plate 10, the thickness of the display panel 100 can further be reduced.

Although the present disclosure is described herein with reference to specific embodiments, it should be understood that these examples are merely examples of the principles and applications of the present disclosure. Therefore, It should be understood that many modifications can be made to the exemplary embodiments and other arrangements can be devised as long as they do not depart from the spirit and scope of the present disclosure as defined by the appended claims. It should be understood that different dependent claims and the features described herein may be combined in a manner different from that described in the original claims. It should also be understood that the features described in connection with the individual embodiments may be used in other described embodiments.

What is claimed is:

1. A display panel, comprising:
a cover plate having a bonding surface and a non-bonding surface, the non-bonding surface facing opposite to the bonding surface;
the cover plate having a main body area and an edge area on the non-bonding surface, the edge area surrounding the main body area;
the cover plate further having a filling groove in the edge area;
an adhesive layer covering the bonding surface of the cover plate; and
a light-shielding glue filled in the filling groove.

2. The display panel according to claim 1, wherein a depth of the filling groove ranges from 20 to 30 um.

3. The display panel according to claim 1, wherein a thickness of the light-shielding glue is equal to a depth of the filling groove.

4. The display panel according to claim 1, wherein the light-shielding glue is ink.

5. The display panel according to claim 1, wherein the display panel further comprises:
a scratch-resistant layer covering the light-shielding glue and the non-bonding surface of the cover plate.

6. The display panel according to claim 1, wherein material of the adhesive layer comprising an optical adhesive.

7. A manufacturing method of a display panel, comprising following steps of:
providing a cover plate, the cover plate having a bonding surface and a non-bonding surface, the non-bonding surface facing opposite to the bonding surface;
wherein the cover plate has a main body area and an edge area on the non-bonding surface, and the edge area surrounds the main body area;
forming a filling groove in the edge area of the cover plate;
filling a light-shielding glue in the filling groove; and
forming an adhesive layer on the bonding surface of the cover plate.

8. The manufacturing method according to claim 7, wherein after the step of forming the light-shielding glue, the manufacturing method further comprises a following step of:
forming a scratch-resistant layer on the non-bonding surface of the cover plate.

9. The manufacturing method according to claim 7, wherein a depth of the filling groove ranges from 20 to 30 um.

10. A display device, comprising:
a display panel, comprising:
a cover plate having a bonding surface and a non-bonding surface, the non-bonding surface facing opposite to the bonding surface;
the cover plate having a main body area and an edge area on the non-bonding surface, the edge area surrounding the main body area;
the cover plate further having a filling groove in the edge area;
an adhesive layer covering the bonding surface of the cover plate; and
a light-shielding glue filled in the filling groove.

11. The display device according to claim 10, wherein a depth of the filling groove ranges from 20 to 30 um.

12. The display device according to claim 10, wherein a thickness of the light-shielding glue is equal to a depth of the filling groove.

13. The display device according to claim 10, wherein the light-shielding glue is an ink.

14. The display device according to claim 10, wherein the display panel further comprises:
a scratch-resistant layer covering the light-shielding glue and the non-bonding surface of the cover plate.

15. The display device according to claim 10, wherein material of the adhesive layer comprising an optical adhesive.

16. The display device according to claim 10, wherein the display panel is made by a manufacturing method of the display panel, the manufacturing method comprises following steps of:
providing the cover plate, the cover plate having the bonding surface and the non-bonding surface, the non-bonding surface facing opposite to the bonding surface;
wherein the cover plate has the main body area and the edge area on the non-bonding surface, and the edge area surrounds the main body area;
forming the filling groove in the edge area of the cover plate;
filling the light-shielding glue in the filling groove; and
forming an adhesive layer on the bonding surface of the cover plate.
